(19) United States
(12) Patent Application Publication
(10) Pub. No.: US 2012/0066318 A1
(43) Pub. Date: Mar. 15, 2012

(54) DATA TRANSMISSION METHOD

(75) Inventors: Wei-Cheng Wang, Santa Ana, CA (US); Ping-Shun Zeung, Santa Ana, CA (US); Chen-Ming Lee, Santa Ana, CA (US); Hong-Yi Huang, Santa Ana, CA (US)

(73) Assignee: I O INTERCONNECT, LTD., Santa Ana, CA (US)

(21) Appl. No.: 13/091,164

(22) Filed: Apr. 21, 2011

Related U.S. Application Data
(63) Continuation-in-part of application No. 12/978,357, filed on Dec. 23, 2010.
(60) Provisional application No. 61/381,134, filed on Sep. 9, 2010.

(51) Int. Cl. G06F 15/16

(52) U.S. Cl. 709/206; 709/246

(57) ABSTRACT

The present invention discloses a data transmission method for a first electronic device and a second electronic device. The method includes the steps of finding a first available port of the first electronic device, finding a second available port of the second electronic device, transforming a first data into a second data, wherein a format of the second data is an XML format, and transmitting the second data to the first electronic device or the second electronic device via the first available port or the second available port.

### CROSS REFERENCE TO RELATED APPLICATIONS

This application claims the benefit of U.S. Provisional Application No. 61/381,134, filed Sep. 9, 2010, the entirety of which is incorporated by reference herein.

This application is a Continuation-In-Part of pending U.S. patent application Ser. No. 12/978,357, filed Dec. 23, 2010 and entitled “NETWORK CONNECTION ESTABLISHMENT AND DATA TRANSMISSION METHOD”.

### BACKGROUND OF THE INVENTION

1. Field of the Invention

The present invention relates to network communications and more particularly to a network connection establishment method using XML format files.

2. Description of the Related Art

A firewall is a part of a computer system or network that is designed to block unauthorized access while permitting authorized communications. It is a device or set of devices that are configured to permit or deny network transmissions based upon a set of rules and other criteria. Firewalls can be implemented in either hardware or software, or a combination of both. Firewalls are frequently used to prevent unauthorized Internet users from accessing private networks connected to the Internet, especially intranets.

### BRIEF SUMMARY OF THE INVENTION

An embodiment of the invention provides a data transmission method for a first electronic device and a second electronic device. The method comprises: finding a first available port of the first electronic device; finding a second available port of the second electronic device; transforming a first data into a second data, wherein a format of the second data is an XML format; and transmitting the second data via the first available port or the second available port to the first electronic device or the second electronic device.

Another embodiment of the invention provides a data transmission method for a first electronic device and a second electronic device. The method comprises scanning a first firewall of the first electronic device to find a first available port of the first electronic device; scanning a second firewall of the second electronic device to find a second available port of the second electronic device; transforming a first data into a second data, wherein a format of the second data is an XML format; and transmitting the second data via the first available port or the second available port to the first electronic device or the second electronic device.

Another embodiment of the invention provides a data transmission system, comprising a first electronic device and a second electronic device comprising a second firewall and providing a second port. When the first electronic device wants to transmit a first data to the second electronic device, the first electronic device transforms the first data into a second data with an XML format, and transmits the second data to the second electronic device via the second port.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a data transmission system according to one embodiment of the invention.

FIG. 2 is schematic diagram of a data transmission system according to another embodiment of the invention.

FIG. 3 is a flowchart of a data transmission method between two electronic devices according to one embodiment of the present disclosure.

FIG. 4 is a schematic diagram of data transmission system according to one embodiment of the invention.

FIG. 5 is a network connection establishment sequence according to one embodiment of the invention.

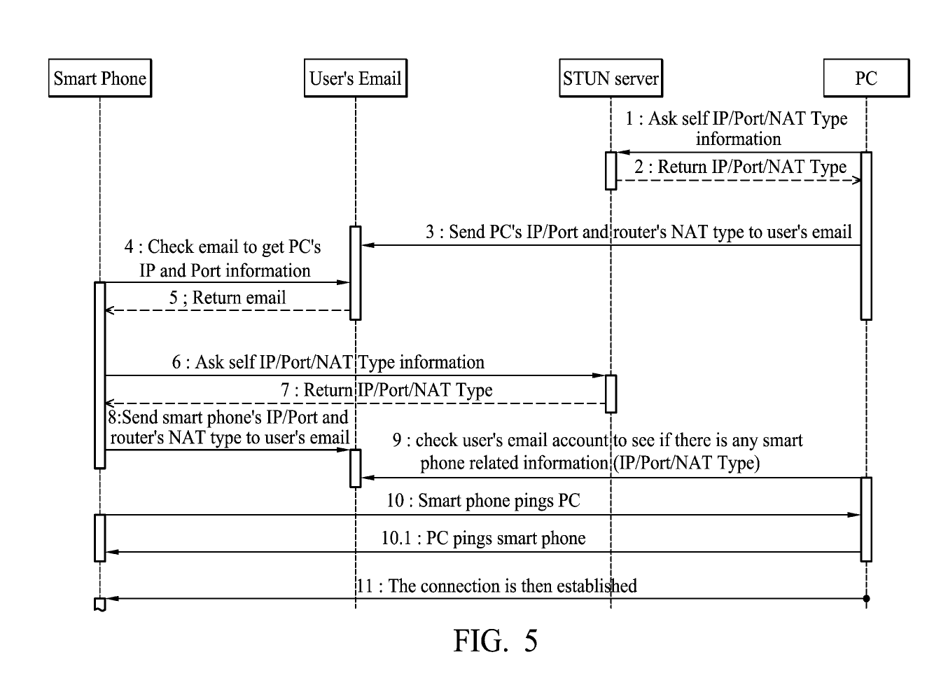

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention discloses a network communication establishment method between a portable device and a computer. The following paragraphs are illustrated with a smart phone and a personal computer (or another portable device), but does not limit the invention thereto. The communication method exchanges some parameters between the portable device and the computer to establish a network connection for data transmission. The major feature of the present invention is a two step data transmission procedure. First, the portable device and the host determine whether there is any available port for the data transmission. If yes, the ports will be exclusively assigned for the data transmission. If not, the data transmission will be created via a third party, such a mail server or message exchanging server.

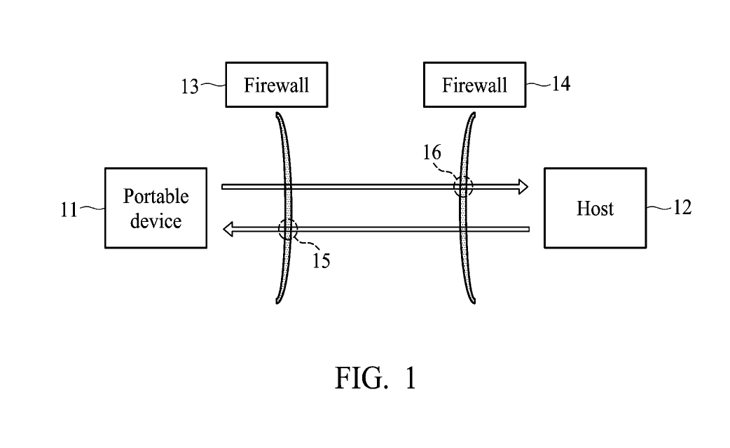

FIG. 1 shows a schematic diagram of a data transmission method according to one embodiment of the invention. The portable device 11 may be a mobile phone, smart phone, PDA (personal digital assistant), laptop, tablet, desktop PC, or other similar mobile electronic device. The portable device 11 comprises a firewall 13 for banning unauthorized access. The host 12 may be another mobile device, personal computer or server as a host and also comprises a firewall 14 for banning unauthorized access. If the user using the portable device 11 wants to transmit data to the host 12 and send a data transmission request to the host 12, but the host cannot recognize the request, the firewall 14 may block the data transmission.

In another situation, if the host 12 wants to read folders or files from the portable device 11 or the portable device 11 wants to read the folders or files from the host 12 but no authorized connection has been established, the communication may fail. Therefore, the present invention provides a data transmission method for solving the problem.

### Data Transmission: Portable Device to the Host

First, the portable device 11 transforms the format of the first data which is transmitted to the host 12 to an XML format or the portable device 11 creates an XML or JSON file containing the first data. Extensible Markup Language (XML) is a set of rules for encoding documents in machine-readable form.

Second, a first application program embedded in the portable device 11 may scan the firewall 13 to find at least one port (hole), such as the port 15, for data transmission. The IP and port are obtained from a well-known rendezvous server located outside of the firewall. The portable device 11 will connect to the rendezvous server via the network and the rendezvous records the IP and the port information of the port 15. The rendezvous server also records the IP and port of the host 12 through the same way. When the portable device 11 initiates a connection to the host 12, it acquires the IP and the available port of the host 12 from the rendezvous server. Also, the host 12 gets the IP and the available port of the portable device 11. In another embodiment, the host 12 and the portable device 11 can scan the firewalls 13 and 14 to find the available port for data transmission by itself.

Third, the portable device 11 transmits the transformed data to the host 12 via the port 16. The first data may be any file except the application program or program code.

### Data Transmission: Host to the Portable Device

First, the host 12 transforms the format of the data which is transmitted to the portable device 11 into an XML format or the host 12 creates an XML file containing the first data. Extensible Markup Language (XML) is a set of rules for encoding documents in machine-readable form.

The IP and port are obtained from a well-known rendezvous server located outside of the firewall. The portable device 11 will connect to the rendezvous server and the rendezvous server records the IP and port information of the portable device 11. The rendezvous server also records the IP and port information of the host 12 through the same way. When the host 12 initiates a connection to the portable device 11, it acquires the IP and port information of the portable device 11 from the rendezvous server, also, the portable device 11 gets the IP and port information of host 12.

Then, the host 12 transmits the transformed data to the portable device 11 via the port 15. The first data may be any file except the application program or program code.

It is noted that the described data transmission maybe implemented in a wireless environment, and the data is transmitted in a specific frequency according to the standard of the wireless environment. For example, IEEE 802.11 standard utilizes 5 GHz band whereas IEEE 802.11 b/g utilize 2.4 GHz band.

If the portable device 11 and the host 12 cannot find any available ports for the data transmission, another data transmission mechanism is provided and described as follows.

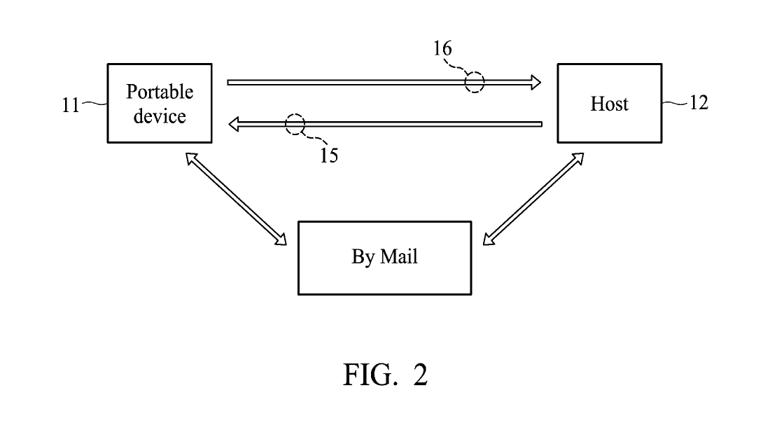

FIG. 2 is a schematic diagram of a data transmission method according to another embodiment of the invention. The portable device 11 may be a mobile phone, smart phone, PDA (personal digital assistant), laptop, tablet, desktop PC, or other similar mobile electronic device. The portable device 11 comprises a firewall 13 for banning unauthorized access. The host 12 may be another mobile device, personal computer or server as a host and also comprises a firewall 14 for banning unauthorized access. The data transmission procedure is described in the following paragraph.

### Data Transmission: Portable Device to the Host

First, the portable device 11 transforms the format of the data which is transmitted to the host 12 to an XML format or the portable device 11 creates an XML file containing a first data. Extensible Markup Language (XML) is a set of rules for encoding documents in machine-readable form.

Second, the portable device 11 sends an email containing the transformed data or the XML file containing the first data to the host 12. When the host 12 receives the email, the host 12 therefore acquires the data. In another embodiment, the portable device 11 sends the mail to a mail account corresponding to the host 12, and when the host 12 found that there is a mail designated to the host 12, the host 12 receives and analyzes the mail to get the first data from the portable device 11.

### Data Transmission: Host to the Portable Device

First, the host 12 transforms the format of a first data which is transmitted to the portable device 11 to an XML format or the host 12 creates an XML file containing the first data.

Second, the host 12 sends an email containing the transformed data or the XML file containing the first data to the portable device 11. When the portable device 11 receives the email, the portable device 11 therefore acquires the data.

In another embodiment, the host 12 sends the mail to a mail account corresponding to the portable device 11, and when the portable device 11 finds that there is a mail designated to the portable device 11, the portable device 11 receives and analyzes the mail to get the first data from the host 12.

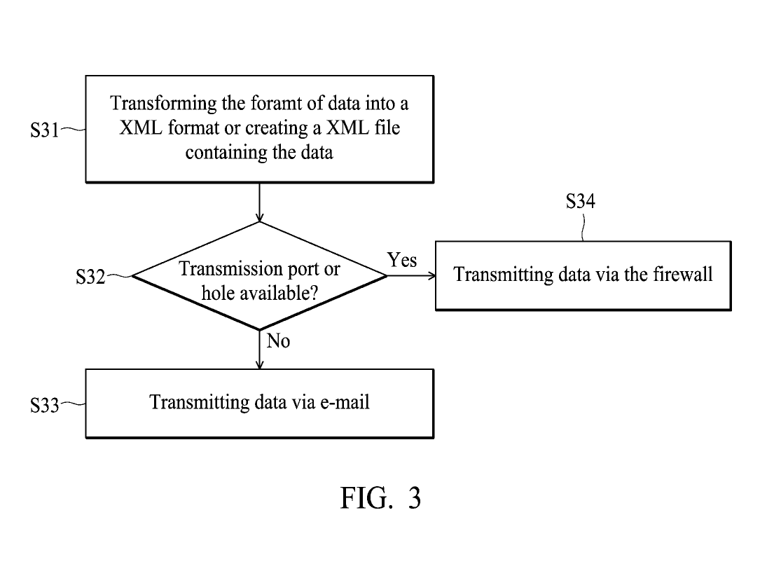

FIG. 3 is a flowchart of a data transmission method between two electronic devices according to one embodiment of the present disclosure. In step S31, the data is transformed to data with an XML (or JSON) format or an XML (or JSON) file containing the data which has to be transmitted is created by an electronic device, such as a mobile phone or computer.

In step S32, both of the electronic devices get their respective IP and port from the rendezvous server to determine whether a free port or hole is available for data transmission. The electronic device scans the respective firewall to find the free port and records the port number of the free port and the IP of the electronic device. If yes, the procedure goes to step S34, and the data is transmitted via the firewalls. Both of the two electronic devices acquires the network information of the free port from the rendezvous server, wherein the network information comprises an IP address, port information (port number) or NAT (network address translator) type information of the electronic devices. If not, the procedure goes to step S33, and the data will be transmitted via an e-mail. In another embodiment, the step S32 may be executed prior to the step S31, and the data format transformation is executed before transmission.

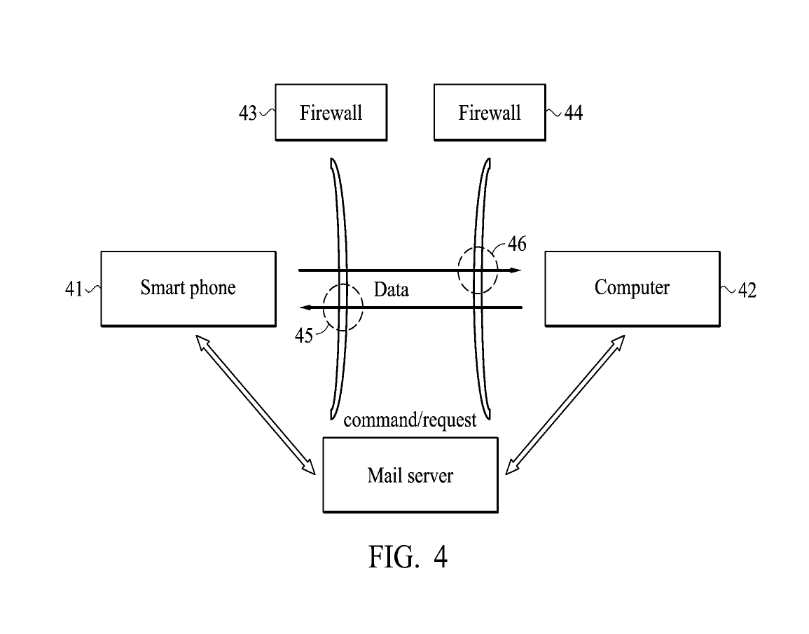

FIG. 4 is a schematic diagram of data transmission system according to one embodiment of the invention. The computer 42 first acquires network information containing the IP address, port information and NAT (network address translator) type information of the computer 42 from a STUN (session traversal utilities for NAT) server. The computer 42 talks to the STUN server every period of time (usually 3 to 30 seconds by the distance of the devices to the server) and sends an email to the user's email account if the IP or Port of the computer 42 changes. In other embodiments, the computer 42 can adjust the time period by a user's requirement, or only when the IP or Port changes, wherein an interrupt signal informs the processor of the computer 42 to acquire the updated network information. The smart phone 41 also acquires its network information comprising IP address, port information, router information and NAT (network address translator) type information from a STUN (session traversal utilities for NAT) server.

When the computer 42 gets its IP address, port information and NAT type information, the computer 42 sends an email comprising the described information to a first email account via the mail server. The embodiment illustrates with the email, however, not to limit the invention thereto. The computer 42 can send a first message, such as a short message, containing the described information to a third party and the third party transfers the message to the smart phone 41. In another example, the first message can be embedded in the first email and sent to the first email account via the mail server. In order to get the IP and Port information of the computer 42, the smart phone will check the email first when an application program (AP) embedded in the smart phone 41 is activated. After the smart phone 41 receives the network information of the computer 42, the smart phone 41 sends the IP, Port and router' s NAT type of the smart phone 41 to a second email account. Similarly, the smart phone 41 can send a second message, such as a short message, containing the described information to a third party and the third party transfers the message to the computer 42. In another example, the second message can be embedded in the second email and sent to the second email account via the mail server. It is noted that the first email account may be the same as the second email account. If the first email account is the same as the second email account, the computer 42 and smart phone 41 determine which email is designated to the computer 42 or smart phone 41 according to the email title or the email content.

The computer 42 will check the second email account at every period of time, such as 30 seconds or so, to determine whether the smart phone 41 is turned on and is trying to connect to the computer 42. When the smart phone 41 receives the network information of the computer 42, the smart phone 41 then pings the computer 42 according to the network information of the computer 42. The computer 42 then responds to the pings of the smart phone 41 according to the network information of the smart phone 41. If the described steps have been completed, the connection between the smart phone 41 and computer 42 is then established. The data is then transmitted via the available port and the command/request is transmitted via an email. When the data is transmitted via an email, a verification procedure may be applied. The verification procedure first verifies the data-under-transmitted of the email, and when the email passes the verification procedure, the verification procedure or other procedure acquires a destination IP address and transmits the email to the destination device according to the destination IP address.

When establishing the network connection, the computer 42 informs the smart phone 41 which port of the firewall 44 is available for data transmission, such as port 46, and the smart phone 41 also informs the computer 42 which port of the firewall 43 is available for data transmission, such as port 45. After the network connection is established, the computer receives data from the smart phone 41 via the port 46 and the smart phone 41 receives data from the computer 42 via the port 45. The following paragraph describes, in more detail, the data transmission mechanism.

### Data Transmitted from the Smart Phone 41 to the Computer 42

A second application program of the smart phone 41 transmits a request to the computer 42 via email and the computer 42 responds to the smart phone 41 with an ACK message via email to inform the computer 42 that the second application program has started to transmit data to the computer 42 and the port 46 must be opened. When the network connection is already established, the control of the port 46 is then transferred to the computer 42. The data is then directly transmitted to the computer 42 via the port 46. When the data is completely transmitted, the second application program transmits a message to the computer 42 via email and the computer 42 closes the port 46.

### Data Transmitted from Computer 42 to the Smart Phone 41

The first application program of the computer 42 transmits a request to the smart phone via email and the smart phone 41 responds to the computer 42 with an ACK message via email to inform the computer 42 that the first application program has started to transmit data to the smart phone 41 and the port 45 is opened. When the network connection is established, the control of port 45 is transferred to the smart phone 41. The data is then directly transmitted to the smart phone 41 via the port 45. When the data is completely transmitted, the first application program transmits a message to the smart phone 41 via email and the smart phone 41 closes the port 45.

### Smart Phone 41 Access Computer 42

When the smart phone 41 wants to acquire some data, folder or files from the computer 42, the smart phone 41 first transmits a command to the computer 42 via email and informs the computer 42 that the port 45 is available for transmission. The computer 42 responds to the smart phone 41 with an ACK message via email to inform the smart phone 41 that that the data is ready to be accessed. The smart phone 41 opens the port 45 and informs the computer 42 to start transmitting data. After data is completely transmitted, the computer 42 sends a message to the smart phone 41 via email and smart phone 41 then stops receiving data and closes the port 45.

### The Computer 42 Access Smart Phone 41

When the computer 42 wants to acquire some data, folder or files from the smart phone 41, the computer 42 first transmits a command to the smart phone 41 via email and informs the smart phone 41 that port 46 is available for transmission. The smart phone 41 then responds to the computer 42 with an ACK message via email to inform the smart phone that that the data is ready to be accessed. The computer 42 opens the port 46 and informs the smart phone 41 to start transmitting data. After the data is completely transmitted, the smart phone 41 sends a message to the computer 42 via email and the computer 42 then stops receiving data and closes the port 46.

FIG. 2 is a network connection establishment sequence according to one embodiment of the invention. The following paragraph describes the network connection establishment sequence step by step.

Step 1: A PC first transmits a request to the STUN server to acquire the PC's network information (first network information) comprising the PC's IP, available port (hole), NAT type information, and other necessary information. The available port means that the PC can receive data from the smart phone through the firewall and the port can be controlled by a first application program (AP) of the PC. The first AP can open the port to receive data or closes the port to stop receiving data from the smart phone.

The PC talks to the STUN server every certain period of time (30 seconds here) and sends an email to the user's account if the PC's IP or Port changes. In other embodiments, the PC can adjust the time period by a user's requirement, or when the PC's IP or Port changes, wherein an interrupt signal informs the first AP to acquire the updated network information.

Step 2: The STUN server returns the first network information to the PC and transfers the control of a first port to the first AP.

Step 3: After receiving the first network information, PC sends the first network information to a first email account.

Step 4: When a second application program (AP) is started, the second AP first checks the first email account to get the first network information.

Step 5: If the first email account receives the email containing the first network information, the email is returned to the smart phone.

After receiving the first network information, the second AP embedded in the smart phone still periodically checks the first email account to see whether the PC's network information has changed.

Step 6: The Smart Phone transmits a request to the STUN server to acquire the Smart Phone's network information (second network information) comprising the Smart Phone's IP, available port (hole), NAT type information, and other necessary information. The available port means that the Smart Phone can receive data from the PC through the firewall and the port can be controlled by a second application program (AP) of the smart Phone. The second AP can open the port to receive data or close the port to stop receiving data from PC.

Step 7: The STUN server returns the second network information to the PC and transfers the control of a second port to the second AP.

Step 8: After receiving the second network information, the Smart Phone sends the second network information to a second email account. The first email account and the second email account may be from the same. PC and smart phone can know which email is designated to the PC or the smart phone according to the e-mail's title, content, sender or other information.

Step 9: The PC or the first AP will check the first email account to see if there is any smart phone related information, such as the second network information. The PC checks the first email account periodically to see if the second AP of the smart phone is on and is trying to connect to the PC.

Step 10: The smart phone pings the PC according to the first network information. Take FIG. 1 for example, the smart phone pings to the PC via the port 16. If the smart phone successfully pings the PC, the smart phone will send a message to the PC.

Step 10.1: The PC pings back to the smart phone according to the second network information to respond to the pings from the smartphone. Take FIG. 1 for example, the PC pings the smart phone via the port 15. If the PC successfully pings the smart phone, the PC will send a message to the smart phone.

Step 11: When the described steps are successfully completed, a network connection between the PC and the smart phone is then established. The data will be transmitted via the network connection, however, the command or request is still transmitted via email.

Although the present invention is described above, other data transmission technologies may also be applied, such as encoding, encrypting, security mechanism and other technologies.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data transmission method for a first electronic device and a second electronic device, comprising:
finding a first available port of the first electronic device;
finding a second available port of the second electronic device;
transforming a first data into a second data, wherein a format of the second data is an XML format; and
transmitting the second data to the first electronic device or the second electronic device via the first available port or the second available port.

2. The method as claimed in claim 1, further comprising:
when the first electronic device cannot find the fist available port for receiving the second data from the second electronic device, the second data is transmitted to the first electronic device via an email.

3. The method as claimed in claim 1, further comprising:
when the second electronic device cannot find the second available port for receiving the second data from the first electronic device, the second data is transmitted to the second electronic device via an email.

4. The method as claimed in claim 1, further comprising:
connecting the first electronic device to a rendezvous server, wherein the rendezvous server storing a first network information of the first available port of the first electronic device; and
acquiring the first network information of the first available port by the second device.

5. The method as claimed in claim 4, wherein the first network information comprises an IP of the first electronic device and a port number of the first available port.

6. The method as claimed in claim 1, further comprising:
connecting the second electronic device to a rendezvous server, wherein the rendezvous server stores a second network information of the second available port of the second electronic device; and
acquiring the second network information of the second available port by the first device.

7. The method as claimed in claim 6, wherein the second network information comprises an IP of the second electronic device and a port number of the second available port.

8. A data transmission method for a first electronic device and a second electronic device, comprising:
scanning a first firewall of the first electronic device to find a first available port of the first electronic device;
scanning a second firewall of the second electronic device to find a second available port of the second electronic device;
transforming a first data into a second data, wherein a format of the second data is an XML format; and
transmitting the second data to the first electronic device or the second electronic device via the first available port or the second available port.

9. The method as claimed in claim 8 further comprising:
when the first electronic device cannot find the fist available port for receiving the second data from the second electronic device, the second data is transmitted to the first electronic device via an email.

10. The method as claimed in claim 8, further comprising:
when the second electronic device cannot find the second available port for receiving the second data from the first electronic device, the second data is transmitted to the second electronic device via an email.

11. A data transmission system, comprising:
a first electronic device; and
a second electronic device, comprising a second firewall and providing a second port;
wherein when the first electronic device wants to transmit a first data to the second electronic device, the first electronic device transforms the first data into a second data with an XML format, and transmits the second data to the second electronic device via the second port.

12. The system as claimed in claim 11, further comprising a rendezvous server for recording an IP of the second electronic device and a port number of the second port, wherein when the first electronic device wants to transmit a first data to the second electronic device, the first electronic device first connects to the rendezvous server to acquire the IP of the second electronic device and the port number of the second port.
